(19) United States
(12) Patent Application Publication
(10) Pub. No.: US 2004/0114777 A1
(43) Pub. Date: Jun. 17, 2004

(54) Electroacoustic conversion of audio signals, especially voice signals

(76) Inventors: Roland Aubauer, Munchen (DE); Andre Fischer, Berlin (DE); Stefano Ambrosius Klinke, Kerpen (DE)

Correspondence Address: BELL, BOYD & LLOYD, LLC, P. O. BOX 1135, CHICAGO, IL, 60690-1135, US

(21) Appl. No.: 10/470,682

(22) PCT Filed: Jan. 29, 2002
(86) PCT No.: PCT/DE02/00299

(30) Foreign Application Priority Data
Jan. 29, 2001 (DE) 101 03 800.3

(51) Int. Cl. H04R 5/02; H04R 1/02

(52) U.S. Cl. 381/333; 381/301; 381/388

(57) ABSTRACT

At least one flexible element (1, 32, 33a, 33b) which converts a mechanical pressure change into an electrical voltage variation (microphone) or an electrical voltage variation into a mechanical pressure change (loudspeaker) is connected to the fabric of items of clothing (30, 300). Furthermore, the flexible element (1, 32, 33a, 33b) is connected, by means of a wire or without, to an audio signal source (31) and/or an audio signal sink (31) which are associated with the item of clothing (30, 300) or integrated into the same (30, 300).

The electroacoustic conversion of audio signals is performed in electroacoustic converters, for example loudspeakers and micro-phones which are either directly integrated in electronic audio devices and telecommunications terminals or disposed separately from these devices.

As a result of the increasingly rapid advances in miniaturization in the field of information, communication and consumer electron-ics as well as telematics, in the course of the miniaturization efforts in these areas over the last several years, particularly with regard to devices which can be worn about the human body, there have been considerations of how to integrate at least individual device components suitable for this, so-called “microsystems”, into clothing. The scenario in which clothing or articles of clothing are used as a medium, carrier and interface for the most diverse Microsystems is subsumed under the term “smart clothes”. Electronically networkable “haute couture” is uncharted territory not only for the clothing industry but also for the information, communication and consumer electronics industry. “Smart clothes” therefore hold out the prospect of new market opportunities for both these branches of industry in the course of cooperative collaboration.

In the future there will therefore be clothing which, in addition to its normal function of protecting the body against environmental influences (e.g. against light, humidity, cold, heat), will comprise further functions in the areas of personal communication and entertainment. As a result of the close contact between the clothing and the body, this type of functional clothing will have sensory functions as well as functions relating to information output, e.g. by means of sound, light, electromagnetic waves, etc.

A problem which has remained unresolved to date is which type of sound converters (microphones and loudspeakers) can be integrated into the clothing and how this can be done so that the sound converters effectively form an entity with the clothing. This is probably also relevant to other sensors, such as for light, heat, electromagnetic waves, etc., which means that the points listed below are to be applied analogously. The objective to be aimed at is that these converters are incorporated in the clothing during the manufacturing process and can therefore remain in the clothing, even during cleaning for example.

Previously, in prototypes of this clothing, conventional earphones (electrodynamic converters) and microphones (electret converters) were attached to the clothing, for example in pockets provided for the purpose, by means of a clip fixing or using Velcro-type (hook and loop) fasteners. These sound converters are connected by means of conventional cables which either hang loose or are routed by means of flaps, channels in the material, etc. Converter of this type must be removed from the clothing before a wash.

The object of the invention is to avoid the disadvantages which result from the prior art.

This object is achieved by the arrangement-related features recited in claim 1 and by the method-related features recited in claim 30.

The invention solves the problem through the use of elements which are preferably flexible films which convert mechanical pressure changes into electrical voltage variations (microphone) or an electrical voltage variation into a mechanical pressure change (loudspeaker). In other words, at least one flexible element which converts a mechanical pressure change into an electrical voltage variation (microphone) or an electrical voltage variation into a mechanical pressure change (loudspeaker) is brought into contact with clothing fabric. Furthermore, the flexible element is connected either by means of wire or wirelessly to an audio signal source and/or audio signal sink assigned to the clothing fabric or integrated with the clothing fabric.

The idea on which the invention is based is to use clothing as a sound converter, wherein clothing and sound converter can be manufactured in a single process.

The advantages of the invention are to enable the user to engage in completely natural handsfree talking in the area of telephony without the assistance of further devices (e.g. headset, handset, hearing aid, clip-on microphones, earphones or headphones). In addition there are wide-ranging design possibilities for acoustic recording and playback, with the result that both a high directional (pick-up) characteristic and 3D sound reproduction are possible. A further advantage is that the flexible element (the sound converter) forms an entity with the clothing. The use of sound converter films (claims 2 to 6) means that normal functions of clothing, such as insulating the body from environment influences, can—but do not necessarily have to—be taken into account. The converters can be incorporated into the clothing already during the manufacturing process and can also remain in the clothing e.g. during cleaning.

Application scenarios in which the invention can advantageously be used are:

Handsfree talking, telecommunications, personal entertainment and personal surround sound systems (3D sound).

Possible materials suitable for the flexible element include, for example, on the one hand flat piezoceramic disks (e.g. PZT), although these have the disadvantage that they are not mechanically flexible, and on the other hand, as recited in claims 2 to 6, novel types of piezoelectric polymer films (Electro Mechanical FIlm—EMFI) or (PolyvinyliDene Fluoride—PVDF). The films referred to are not flat, but are curved with a small radius (slightly concave or convex film). The EMFI and PVDF polymer films possess almost ideal properties for the object to be achieved:

highly flexible, thin film 30-70 μm thick

almost pure thickness vibration with a sensitivity von 200 pm/V

reversible effect, i.e. can be used both as microphone and as loudspeaker

can be metallized on both sides, enabling electrical contact to be established over a large area

The EMFI films exhibit a piezoelectric sensitivity in the longitudinal direction and only a very slight piezoelectric sensitivity in the transverse direction, with the result that in loudspeaker mode of large film areas there is practically no possibility of large-area deformation of the clothing.

The PVDF films exhibit precisely the reverse characteristics.

These possess a piezoelectric sensitivity in the transverse direction and only a very slight piezoelectric sensitivity in the longitudinal direction, with the result that in loudspeaker mode of large film areas large-area deformation of the clothing can occur.

According to claim 7, the sound converter films or the piezoceramic disks can be advantageously connected to the fabric of the clothing by means of gluing, bonding or other joining techniques. In this case the sound converters are usually protected on both sides by layers of fabric according to claims 4 and 5.

According to claim 8, instead of connecting the flexible element (sound converter) to the fabric of the clothing it is also possible to provide fabric fibers already with the components of the flexible element so that, when the fabric fibers are interwoven and electrically interconnected, these in combination convert a mechanical pressure change into an electrical voltage variation (microphone) or an electrical voltage variation into a mechanical pressure change (loudspeaker). By this means the process step “connect the flexible element to the clothing fabric” can be dispensed with.

By means of a suitable arrangement of a plurality of separately controllable converter elements it is possible to realize either a controllable directional effect of a converter element receiving the sound (microphone) according to claim 9 or a stereo sound playback or a three-dimensional sound playback of a converter element reproducing the sound (loudspeaker) according to claim 10. For this purpose a plurality of converter elements, also sound converter films that are electrically separated from one another, are arranged in a distributed manner, e.g. over the collar or inside a hood.

Furthermore, the efficiency of the sound conversion can be improved by stacking of the sound converters.

According to claim 11, controlling the sound converters by means of an ultrasound signal modulated with the audio signal is also conceivable in addition to direct control of the sound converters by means of an audio signal. The ultrasound signal is then demodulated by means of a further acoustically non-linear layer of the clothing or through propagation in the air such that the audio signal becomes audible at the recipient's ear (cf. the publication: “The Use of Airborne Ultrasonics for Generating Audible Sound Beams”, F. J. Pompei, AES Vol.47, No. 9, 09/1999).

According to claim 12, it is advantageous for bass reproduction if the flexible element has at least a surface area in the order of 100 cm². Claims 13 to 21 specify various electronic devices which are advantageously implemented as an audio signal source and/or audio signal sink in combination with the flexible element (sound converter). These are telecommunications devices—e.g. mobile phones, mobile components of cordless telephones, etc.—as well as playback devices and/or recording devices for music or voice—e.g. CD players, answering machines, dictation machines, personal computers, personal digital assistants (PDAs) etc.

According to claim 22, electrical leads are present in the clothing fabric which set up the connection between the flexible element (sound converter) and the audio signal source and/or audio signal sink. In contrast to the alternative in which the connection between the flexible element or the sound converter and the audio signal source and/or audio signal sink is implemented without the use of wires, because of the direct wired connection to the audio signal source and/or audio signal sink the flexible element according to claim 1 does not need to be connected to an additional control module according to claim 23 which either (in the case of the loudspeaker) receives the signals transmitted by the audio signal source and/or audio signal sink and intended for the sound converter and possibly amplifies these and in addition controls the supply of power to the sound converter or (in the case of the microphone) transmits the signals transmitted by the sound converter over the air and intended for the audio signal source and/or audio signal sink and for this purpose possibly amplifies these signals and in addition controls the supply of power to the sound converter. Instead of this, the sound converter according to claim 22 in conjunction with claim 1 is operated and controlled entirely by the audio signal source and/or audio signal sink.

The leads or conductor tracks necessary for the electrical connection of the sound converters can be applied to different fabric or intermediate layers of the clothing e.g. by vapor deposition or printing. Equally, however, the sound converters can also establish electrical contact in the conventional way with the aid of electric cables (e.g. by soldering, gluing, bonding) or also connected in a contactless manner by means of electrical induction and thus connected with the corresponding electronic circuit for recording or reproducing the sound.

Whereas the solution according to claims 1 and 22 has the advantage that no additional control module is required, the solution according to claims 1 and 23 has the advantage that no leads or conductor tracks are required. As a result this also dispenses with the process step in the production of an arrangement for electroacoustic conversion of audio signals, particularly voice signals, by means of which the leads are incorporated in the clothing fabric.

According to claim 25, it is advantageous if the flexible element or the sound converter is disposed in areas of the article of clothing which are in proximity to the head when the article of clothing is being worn (put on). According to claim 26, these are in particular the collar, scarf, tie, bow tie, headwear (hood, cap, hat, etc.), chest, back and shoulder areas of articles of clothing.

In this connection it is advantageous if the flexible element or sound converter according to claim 24 is disposed on the article of clothing separately from the audio signal source and/or audio signal sink.

Finally, it is advantageous according to claims 27 to 29 if the flexible element or the sound converter can be removed from the clothing so that they can be used as accessories with different articles of clothing. The flat and flexible sound converters can therefore be attached to the particular article of clothing e.g. by means of hook and loop fasteners according to claim 28 and the electrical contact established according to claim 29, similar to an epaulette. The fact that the sound converter is detachable means that it is possible that if the converters are not sufficiently robust they can be easily removed, for example before the clothes are washed. However, the removable converter unit may also contain a complete receiver and transmitter including power supply which transmits the signals e.g. via radio to an external device.

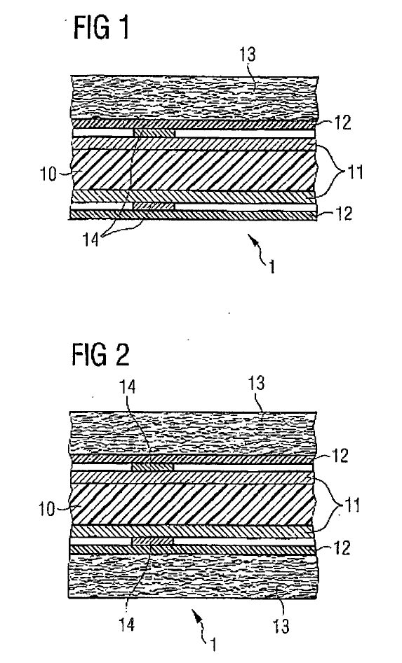

An exemplary embodiment of the invention is explained with reference to the FIGS. 1 to 6, in which:

FIG. 1 shows a cross-section through a flexible element for the electroacoustic conversion of audio signals, particularly voice signals, according to a first embodiment,

FIG. 2 shows a cross-section through a flexible element for the electroacoustic conversion of audio signals, particularly voice signals, according to a second embodiment,

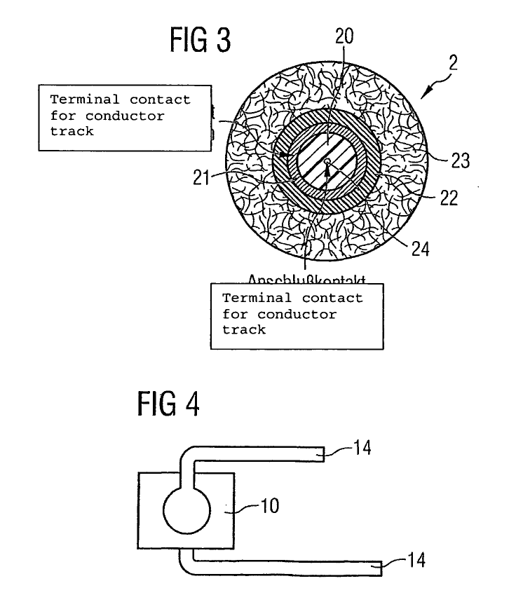

FIG. 3 shows a cross-section through a fabric fiber for the manufacture of a flexible element for the electroacoustic conversion of audio signals, particularly voice signals,

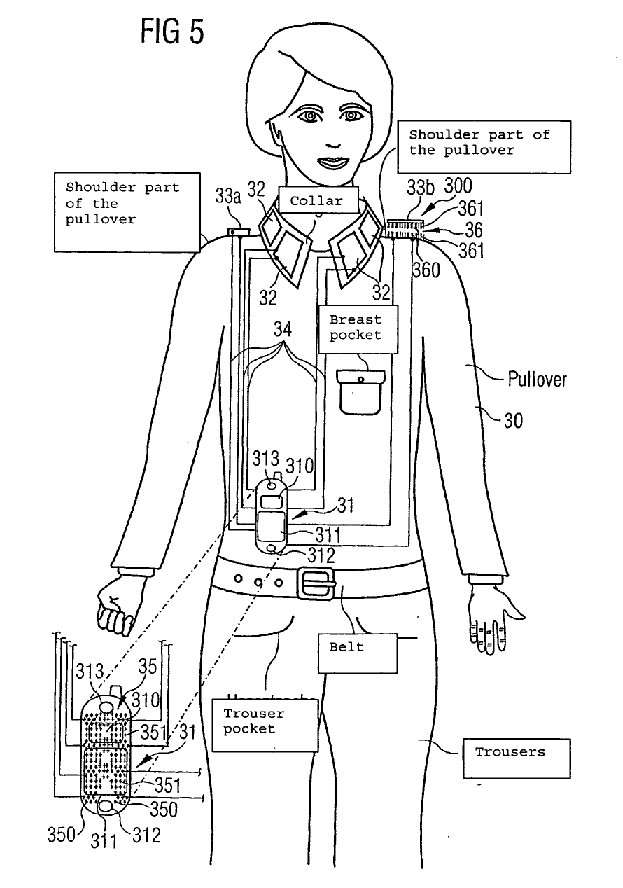

FIG. 4 shows a film of the flexible element according to FIGS. 1 and 2, said film being provided with conductor tracks,

FIG. 5 shows a first embodiment of an arrangement for the electroacoustic conversion of audio signals, particularly voice signals,

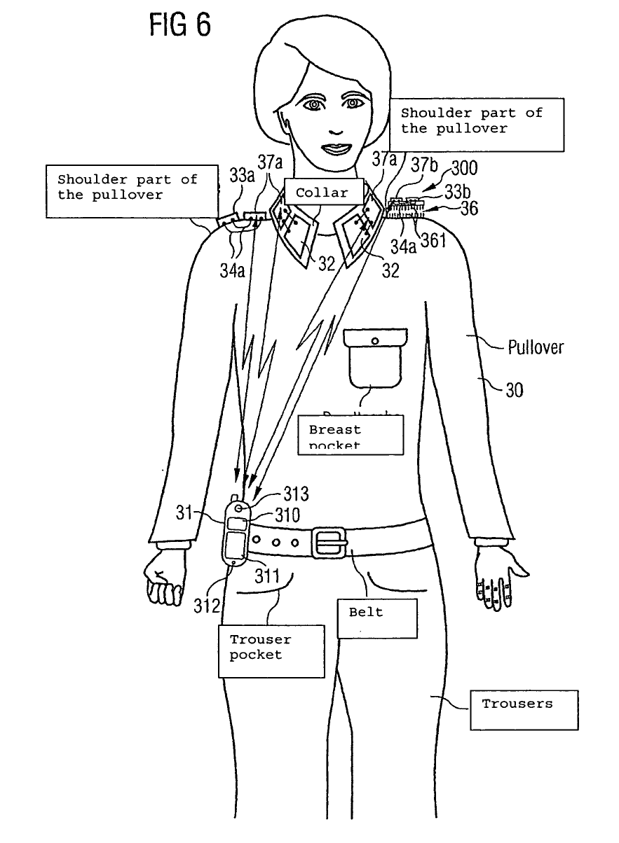

FIG. 6 shows a second embodiment of an arrangement for the electroacoustic conversion of audio signals, particularly voice signals.

FIG. 1 shows a cross-section through a flat flexible element 1, preferably having a surface area in the order of 100 cm², for electroacoustic conversion of audio signals, particularly voice signals, according to a first embodiment. The flexible element 1 has a piezoelectric polymer film 10 which is preferably realized as EMFI film (Electro Mechanical FIlm) or as PVDF film (PolyVinyliDene Fluoride). Contrary to the illustration in FIG. 1, the films 10 referred to are not flat, but have a convex or concave curvature with a small radius. The EMFI or PVDF polymer film 10 is highly flexible and has a thickness of approx. 30 to 70 μm. The film 10 vibrates almost exclusively in the thickness with a sensitivity of 200 pm/V. Furthermore, the film 10 is suitable for use both as a sound converter which converts a mechanical pressure change into an electrical voltage variation, i.e. functions as a microphone, and also as a sound converter which converts an electrical voltage variation into a mechanical pressure change, i.e. functions as a loudspeaker.

The EMFI film 10 exhibits a piezoelectric sensitivity in the longitudinal direction and only a very slight piezoelectric sensitivity in the transverse direction, which means that in loudspeaker mode of large film areas there is practically no possibility of large-area deformation of the clothing occurring.

The PVDF film 10 exhibits precisely the reverse characteristics. This possesses a piezoelectric sensitivity in the transverse direction and only a very slight piezoelectric sensitivity in the longitudinal direction, which means that in loudspeaker mode of large film areas large-area deformation of the clothing can occur.

For electrical contacting purposes, a metal layer 11 is applied on the film 10 preferably on both sides at least over part of the surface area in each case—but preferably over the entire film 10 in the interests of making better electrical contact. It is furthermore possible to apply the metal layer 11 to one side only.

Contained on the metal layer 11 for the purpose of providing electrical insulation there is in each case an insulating layer 12, which may preferably be implemented as a film. The insulating layer 12 implemented as an intermediate layer is required particularly when the material or fabric insulation is not suitable for keeping the voltage necessary for the operation of the sound converters as a loudspeaker or microphone away from the user. This means that the insulating layer 12 can be dispensed with if the material or fabric insulation is sufficient for electrical insulation.

According to FIG. 1, one of these insulating layers 12 is provided with a material or fabric layer 13. The material or fabric layer 13 is joined to the metallized and insulated film 10 by means of gluing, bonding or other joining techniques. In the embodiment according to FIG. 1, the insulating layer 12 thus forms an outer layer of the flexible element 1 which comes into contact e.g. with the skin of the person who is wearing the article of clothing with whose fabric the flexible element 1 is connected. Alternatively, however, it is also possible that the side of the flexible element 1 which is coated with the material or fabric comes into contact with the skin of the person who is wearing the article of clothing.

To provide electrical contact for the film 10, conductor tracks 14 are attached to the two metal layers 11, said tracks being present e.g. on fabric layers or other intermediate layers of the article of clothing (cf. FIGS. 5 and 6).

Taking FIG. 1 as a basis, FIG. 2 shows a cross-section through the flat flexible element 1, again preferably having a surface area in the order of 100 cm², for electroacoustic conversion of audio signals, particularly voice signals, according to a second embodiment. This second embodiment differs from the first embodiment in that the metallized, insulated film 10 has the material or fabric layer 13 on both sides. In this embodiment, in contrast to the embodiment according to FIG. 1, it is no longer possible to recognize immediately or to sense by skin contact that the article of clothing is equipped with the flexible element 1 for electroacoustic conversion of audio signals, particularly voice signals. Apart from this, the statements relating to FIG. 1 are equally valid for FIG. 2.

FIG. 3 shows a cross-section through a fabric fiber 2 which is used in the manufacture of a flexible element for electroacoustic conversion of audio signals, particularly voice signals. The composition or structure of the fabric fiber 2 corresponds in respect of the materials used to the composition or structure of the flexible element 1 according to FIGS. 1 and 2. Internally, the fabric fiber 2 contains a piezoelectric polymer core 20 which is preferably implemented as an EMFI (Electro Mechanical FIlm) core or as a PVDF (PolyVinyliDene Fluoride) core. Around this core 20 there is a metal layer 21 for providing an electrical contact for the core 20, said metal layer being surrounded in turn by an insulating layer 22 serving for electrical insulation. The insulating layer 22 again implemented as an intermediate layer is required particularly when the material or fabric insulation of the fabric fiber is not suitable for keeping the voltage necessary for the operation of the sound converters as a loudspeaker or microphone away from the user. In other words, the insulating layer 12 can be dispensed with if the material or fabric insulation of the fabric fiber is sufficient for electrical insulation.

The outer termination of the fabric fiber 2 is formed by a material or fabric layer 23 which completely surrounds or sheathes the insulating layer 22.

For the purpose of contacting the core 20 with conductor tracks which are present e.g. on fabric layers or other intermediate layers of the article of clothing (cf. FIGS. 5 and 6), a metallic contact pad 24 is present on at least one front part of the fabric fiber 2 in the area of the core 20, said contact pad serving together with the metallization 21 on at least one of the front parts of the fabric fiber 2 as a terminal contact for the conductor tracks.

FIG. 4 shows the film 10 of the flexible element 1 according to FIGS. 1 and 2, said film being provided with conductor tracks 14. The conductor tracks 14 necessary for the electrical connection of the sound converters can be applied to different fabric or intermediate layers of the clothing e.g. by vapor deposition or printing. Equally, however, the sound converters can also be contacted in the conventional way with the aid of electric cables (e.g. by soldering, gluing, bonding) or also connected in a contactless manner by means of electrical induction and thus connected with the corresponding electronic circuit for recording or reproducing the sound.

FIG. 5 shows a first embodiment of an arrangement 3 for electroacoustic conversion of audio signals, particularly voice signals, in the form of functional clothing having integrated flexible elements (sound converters) according to FIGS. 1 and 2 which are implemented as a microphone or loudspeaker or earpiece and which in some cases may be removed from the clothing.

The arrangement 3 comprises an article of clothing 30, e.g. a pullover, to which a mobile phone 31 is assigned as audio signal source and/or audio signal sink and the fabric of which is connected to sound converters 32, 33a, 33b which are configured as flexible elements 1 according to FIGS. 1 and 2. Also present in the article of clothing 30 are conductor tracks 34 running on fabric layers or intermediate layers of the clothing fabric, said conductor tracks being comparable with the conductor tracks 14 in FIGS. 1 and 2 and connecting the mobile phone 31 assigned to the article of clothing 30 to the sound converters 32, 33a, 33b.

As an alternative to the assignment of the mobile phone 31 to the article of clothing 30, it is also possible, subject to appropriate miniaturization of the mobile phone 31, to integrate the mobile phone 31 into the article of clothing 30.

In the illustrated embodiment the assignment is effected by means of a hook and loop fastener 35 via which the mobile phone 31 is connected to the conductor tracks 34 and thus to the sound converters 32, 33a, 33b. It is understood per se that any other assignment system than the hook and loop fastener is also possible in principle or may be considered provided on the one hand it enables the audio signal source and/or audio signal sink to be assigned to the article of clothing and on the other hand it establishes the necessary connection to the conductor tracks in the article of clothing.

The mobile phone 31 is preferably constructed in the conventional way. Thus, for example, the user interface comprises a display 310, a keyboard 311, a microphone 312 and an earpiece 313. Alternatively, however, it is also possible to slim down the mobile phone 31 to the extent that it no longer includes a microphone or an earpiece and consequently mutates into a pure clip-on mobile phone which will function as a telephone only in conjunction with an article of clothing.

The hook and loop fastener 35, as is known, is implemented in two parts, each part having a plurality of barbs. A first part resides on a first object (in this case: the mobile phone) which is to be connected to a second object (in this case: the article of clothing) in the form of an assignment or detachable fixing, whereas a second part resides on the second object. When the two objects are brought together, the barbs interlock detachably—i.e. can be disengaged by tearing apart—and in this way establish the intended connection.

In the case of the hook and loop fastener 35 according to FIG. 5, a distinction is made between first barbs 350 which are implemented as electrically conductive and second barbs 351 which are implemented as non electrically conductive. By means of the first barbs 350, on the one hand the electrical connection between the mobile phone 31 and the conductor tracks 34 is established and on the other hand the mechanical assignment (detachable fixing) of the mobile phone 31 to the article of clothing 30 is achieved, whereas the second barbs 351 are used only for the mechanical assignment. It is understood per se here that the barbs 350, 351 are in each case arranged accordingly on the parts of the hook and loop fastener such that there is no possibility of incorrect interlockings which do not initiate the electrical connection or of short-circuits.

Of the sound converters 32, 33a, 33b connected to the fabric of the article of clothing 30 and implemented as flexible elements 1 according to FIGS. 1 and 2, a first converter 32 is implemented as a microphone and accommodated in the collar of the article of clothing 30, while second converters 33a, 33b are implemented as a loudspeaker and earpiece respectively and are accommodated in the shoulder parts of the article of clothing 30, of which the one 33a is permanently joined to the fabric of the article of clothing 30 and the other 33b is detachably joined to the article of clothing 30 in a removable piece of clothing 300 by being joined to the fabric of the latter.

The removable piece of clothing 300 is in turn detachably fixed to the article of clothing 30 by means of a further hook and loop fastener 36. The hook and loop fastener 36 is again constructed in two parts in the known manner, each part having a plurality of barbs. A first part resides on a first object (in this case: the removable piece of clothing) which is to be connected to a second object (in this case: the article of clothing) in the form of an assignment or detachable fixing, whereas a second part resides on the second object. When the two objects are brought together, the barbs interlock detachably—i.e. can be disengaged by tearing apart—and in this way establish the intended connection.

In the case of the hook and loop fastener 36 according to FIG. 5, a distinction is made between further first barbs 360 which are implemented as electrically conductive and further second barbs 361 which are implemented as non electrically conductive. By means of the first barbs 360, on the one hand the electrical connection between the removable piece of clothing 300 and the conductor tracks 34 is established and on the other hand the mechanical assignment (detachable fixing) of the removable piece of clothing 300 to the article of clothing 30 is achieved, whereas the second barbs 361 are used only for the mechanical assignment. It is again understood per se here that the barbs 360, 361 are in each case arranged accordingly on the parts of the hook and loop fastener such that there is no possibility of incorrect interlockings which do not initiate the electrical connection or of short-circuits.

FIG. 6 shows a second embodiment of the arrangement 3 for electroacoustic conversion of audio signals, particularly voice signals, in the form of functional clothing having integrated flexible elements (sound converters) according to FIGS. 1 and 2 which are implemented as a microphone or loudspeaker or earpiece and which in some cases may be removed from the clothing.

The arrangement 3 comprises a further article of clothing 30, e.g. a pullover, to which a further mobile phone 31 is assigned as audio signal source and/or audio signal sink and the fabric of which is connected to sound converters 32, 33a, 33b which are configured as flexible elements 1 according to FIGS. 1 and 2. In contrast to FIG. 5, in this case the connection between the mobile phone 31 and sound converters 32, 33a, 33b in the article of clothing 30 is realized by wireless means, preferably in accordance with one of the known standards for wireless telecommunication. For this purpose the mobile phone 31 is connected to control modules 37a, 37b over the air, said control modules in turn being connected to the sound converters 32, 33a, 33b via leads 34a which again run on fabric layers or intermediate layers of the clothing fabric and at the same time are joined, like the sound converters 32, 33a, 33b, to the fabric of the article of clothing 30. In the case of the sound converter 32, the control module 37a, 37b has the task of transmitting the signals transmitted by the sound converter 32 and intended for the mobile phone 31 over the air and for this purpose amplifying the signals if necessary and also controlling the supply of power to the sound converter 32. In the case of the sound converter 33a, 33b, the task of the control module is to receive the signals transmitted by the mobile phone 31 and intended for the sound converter 33a, 33b and amplify the signals if necessary and also control the supply of power to the sound converter 33a, 33b.

As an alternative to the assignment of the mobile phone 31 to the article of clothing 30 it is also possible, given appropriate miniaturization of the mobile phone 31, to integrate the mobile phone 31 into the article of clothing 30.

The mobile phone 31 is preferably constructed in the conventional way. Thus, for example, the user interface comprises a display 310, a keyboard 311, a microphone 312 and an earpiece 313. Alternatively, however, it is also possible to slim down the mobile phone 31 to the extent that it no longer includes a microphone or an earpiece and consequently mutates into a pure clip-on mobile phone which will function as a telephone only in conjunction with an article of clothing.

Of the sound converters 32, 33a, 33b connected to the fabric of the article of clothing 30 and implemented as flexible elements 1 according to FIGS. 1 and 2, a further first converter 32 is implemented as a microphone and accommodated in the collar of the article of clothing 30, while further second converters 33a, 33b are implemented as loudspeaker and earpiece respectively and are accommodated in the shoulder parts of the article of clothing 30, of which the one 33a is in turn permanently joined to the fabric of the article of clothing 30 and the other 33b is in turn detachably joined to the article of clothing 30 in a further removable piece of clothing 300 by being joined to the fabric of the latter.

Of the control modules 37a, 37b connected to the fabric of the article of clothing 30, a first module 37a is permanently joined to the fabric of the article of clothing 30 and in this case is accommodated either like the sound converter 32 in the collar or like the sound converter 33a in the shoulder part of the article of clothing 30, while a second module 37b, like the sound converter 33b, is detachably connected to the article of clothing 30 in the further removable piece of clothing 300 by being joined to the fabric of the latter and is accommodated in the shoulder parts of the article of clothing 30.

The removable piece of clothing 300 is in turn detachably fixed to the article of clothing 30 by means of a further hook and loop fastener 36. The hook and loop fastener 36 is again constructed in two parts in the known manner, each part having a plurality of barbs. A first part resides on a first object (in this case: the removable piece of clothing) which is to be connected to a second object (in this case: the article of clothing) in the form of an assignment or detachable fixing, whereas a second part resides on the second object. When the two objects are brought together, the barbs interlock detachably—i.e. can be disengaged by tearing apart—and in this way establish the intended connection.

In the case of the hook and loop fastener 36 according to FIG. 6, there are, in contrast to FIG. 5, only the second barbs 361 which are implemented as non electrically conducting and are used for the mechanical assignment only.

1. An arrangement for electroacoustic conversion of audio signals, particularly voice signals, having the following features:
(a) at least one flexible element (1, 32, 33a, 33b) which converts a mechanical pressure change into an electrical voltage variation (microphone) or an electrical voltage variation into a mechanical pressure change (loudspeaker) is connected to the fabric of articles of clothing (30, 300),
(b) the flexible element (1, 32, 33a, 33b) is connected by wired or wireless means to an audio signal source (31) and/or audio signal sink (31) assigned to the article of clothing (30, 300) or integrated into the article of clothing.

2. The arrangement according to claim 1, characterized in that
the flexible element (1, 32, 33a, 33b) consists of a piezoelectric film (10) which has a metal layer (11) on the film topside and underside over at least part of the surface area in each case for the purpose of making electrical contact.

3. The arrangement according to claim 2, characterized in that
the flexible element (1, 32, 33a, 33b) has an insulating layer (12) which is present on the metal layer (11).

4. The arrangement according to claim 2, characterized in that
the flexible element (1, 32, 33a, 33b) is connected to the clothing fabric (30, 300) on the film topside and underside.

5. The arrangement according to claim 3, characterized in that
the flexible element (1, 32, 33a, 33b) is connected to the clothing fabric (30, 300) on the film topside and/or film underside.

6. The arrangement according to one of the claims 2 to 5, characterized in that
the film (10) is an EMFI film or a PVDF film.

7. The arrangement according to one of the claims 1 to 6, characterized in that
the connection between the clothing fabric (30, 300) and the flexible element (1, 32, 33a, 33b) is a glued or bonded connection.

8. The arrangement according to claim 1, characterized in that
the flexible element (1, 32, 33a, 33b) has a plurality of fabric fibers (2), wherein each fabric fiber (2) in the fiber cross-section is constructed like the flexible element (1, 32, 33a, 33b) in cross-section and wherein the fabric fibers (2) are interwoven and electrically interconnected in such a way that in combination they convert a mechanical pressure change into an electrical voltage variation (microphone) or an electrical voltage variation into a mechanical pressure change (loudspeaker).

9. The arrangement according to one of the claims 1 to 8, characterized in that
the number of flexible elements (1, 32, 33a, 33b) is dimensioned and controllable such that during reception the sound can be influenced in terms of its directional efficiency.

10. The arrangement according to one of the claims 1 to 8, characterized in that
the number of flexible elements (1, 32, 33a, 33b) is dimensioned and controllable such that for playback the sound is reproduced with stereo or 3D playback quality.

11. The arrangement according to one of the claims 1 to 8, characterized in that
the flexible element (1, 32, 33a, 33b) is controllable by means of an ultrasound signal modulated with the audio signal such that an ultrasound signal modulated with the audio signal is reproduced, the ultrasound signal being demodulated by means of a further acoustically non-linear layer of the clothing or through propagation in the air.

12. The arrangement according to one of the claims 1 to 11, characterized in that
the flexible element (1, 32, 33a, 33b) has at least a surface area in the order of 100 cm².

13. The arrangement according to one of the claims 1 to 12, characterized in that
a telecommunications device is configured as an audio signal source and/or audio signal sink.

14. The arrangement according to claim 13, characterized in that the telecommunications device is a mobile phone.

15. The arrangement according to claim 13, characterized in that
the telecommunications device is a mobile component of a cordless telephone.

16. The arrangement according to one of the claims 1 to 12, characterized in that
a playback device for music or voice is configured as the audio signal source.

17. The arrangement according to claim 16, characterized in that
the playback device is a CD player.

18. The arrangement according to claim 16, characterized in that
the playback device is an answering machine.

19. The arrangement according to one of the claims 1 to 12, characterized in that
a recording device for music or voice is configured as the audio signal sink.

20. The arrangement according to claim 19, characterized in that the recording device is a dictation machine.

21. The arrangement according to claim 16 or 19, characterized in that
the playback device and/or recording device is a personal computer.

22. The arrangement according to one of the claims 1 to 21, characterized in that
contained in the clothing fabric (30, 300) are electrical leads (34) which establish the connection between the flexible element (1, 32, 33a, 33b) and the audio signal source (31) and/or the audio signal sink (31).

23. The arrangement according to one of the claims 1 to 22, characterized in that
a control module (37a, 37b) is assigned to the flexible element (1, 32, 33a, 33b), said control module establishing the wireless connection between the flexible element (1, 32, 33a, 33b) and the audio signal source (31) and/or the audio signal sink (31) and at the same time ensuring the operability of the element (1, 32, 33a, 33b) without a wired connection between the flexible element (1, 32, 33a, 33b) and the audio signal source (31) and/or audio signal sink (31).

24. The arrangement according to one of the claims 1 to 23, characterized in that
the flexible element (1, 32, 33a, 33b) or the control module (37a, 37b) and the flexible element (1, 32, 33a, 33b) is or are disposed on the article of clothing (30, 300) separately from the audio signal source (31) and/or audio signal sink (31).

25. The arrangement according to one of the claims 1 to 24, characterized in that
the flexible element (1, 32, 33a, 33b) or the control module (37a, 37b) and the flexible element (1, 32, 33a, 33b) is or are disposed in areas of the article of clothing (30, 300) which are located in proximity to the head when the article of clothing (30, 300) is being worn.

26. The arrangement according to claim 25, characterized in that
collar, scarf, headwear, tie, bow tie, chest, back and/or shoulder part are the areas of the article of clothing.

27. The arrangement according to one of the claims 1 to 26, characterized in that
the flexible element (1, 32, 33a, 33b), the control module (37a, 37b) and the flexible element (1, 32, 33a, 33b) and also the audio signal source (31) and/or the audio signal sink (31) are disposed removably on the article of clothing (30, 300).

28. The arrangement according to claim 27, characterized in that
hook and loop systems (35, 36) are present by means of which the flexible element (1, 32, 33a, 33b), the control module (37a, 37b) and the flexible element (1, 32, 33a, 33b) and also the audio signal source (31) and/or the audio signal sink (31) are disposed removably on the article of clothing (30, 300).

29. The arrangement according to claim 28, characterized in that
hook and loop systems (35, 36) are implemented in such a way (350, 351) that electrical contact can be established via these systems.

30. A method for electroacoustic conversion of audio signals, particularly voice signals, with the following features:
(a) at least one flexible element (1, 32, 33a, 33b) which converts a mechanical pressure change into an electrical voltage variation (microphone) or an electrical voltage variation into a mechanical pressure change (loudspeaker) is connected to clothing fabric (30, 300),
(b) the flexible element (1, 32, 33a, 33b) is connected by wired or wireless means to an audio signal source (31) and/or audio signal sink (31) assigned to the clothing fabric (30, 300) or integrated in the clothing fabric.
